(19) United States
(12) Patent Application Publication
(10) Pub. No.: US 2011/0318442 A1
(43) Pub. Date: Dec. 29, 2011

(54) APPARATUS FOR PRODUCING MONOFILAMENTS OR RIBBONS

(75) Inventors: Jens Weinhold, Chemnitz (DE); Joachim Lauckner, Chemnitz (DE)

(73) Assignee: OERLIKON TEXTILE GMBH, Remscheid (DE)

(21) Appl. No.: 13/203,961

(22) PCT Filed: Mar. 8, 2010
(86) PCT No.: PCT/EP10/52902

§ 371 Date: Aug. 30, 2011

(30) Foreign Application Priority Data
Mar. 30, 2009 (DE) 10 2009 015 557.0

(51) Int. Cl. B28B 7/38; D01D 10/04

(52) U.S. Cl. 425/91

(57) ABSTRACT

The invention relates to an apparatus for producing monofilaments or ribbons which are guided in parallel through several treatment devices in an extrusion process. For this purpose, an extrusion device is connected downstream in several treatment device, wherein for guiding the monofilaments or ribbons at least one rod-shaped guide element is provided which has a contact surface for guiding the ribbons or monofilaments. In order to enable low-friction and wear-resistant guidance, in particular when using very elastic monofilaments or ribbons, the contact surface has a multiple coating comprising several coating materials that are applied in several single coatings, each with a different layer thicknesses, wherein the single coatings are formed in a sandwich-like manner on the contact surface.

The invention relates to an apparatus for producing monofilaments or ribbons as defined in the preamble of claim 1.

A generic apparatus is disclosed, for example, in DE 10 2005 049 163 A1.

The apparatus disclosed comprises an extrusion device and several treatment devices to produce a plurality of ribbons from an extruded film. In order to prevent the group of ribbons from sticking to the heating surface of the heating device when being guided through the heating device as a result of a breakage of the individual ribbons, the heating surface is equipped with a nonstick coating.

Furthermore, it is well-known that such nonstick coatings, for example, those made of Teflon, form a particularly advantageous low-friction contact surface for guiding monofilaments or ribbons. In particular, it is desirable to use low-friction guide elements in the production of turf yarn that exhibits a relatively high degree of elasticity. Consequently, it is also well-known to use guide elements having a low-friction coating in the apparatus disclosed. However, it has been observed, during operation, that such low-friction coatings are not very wear-resistant and they therefore necessitate a frequent replacement of such guide elements.

It is therefore an object of the present invention to further develop a generic apparatus for producing monofilaments or ribbons such that the surfaces of the guide elements are both low-friction and wear-resistant.

According to the invention, this object is achieved in that the contact surface has a multiple coating comprising several coating materials, the multiple coating is formed by several single coatings, each with a different layer thickness, and the single coatings are formed in a sandwich-like manner on the contact surface.

Advantageous embodiments of the invention are defined by the features and combinations of features of the subordinate claims.

The invention has the special advantage that the property of the contact surface is characterized by several coating materials so that different surface properties are operative in combined form on the contact surface. In particular, the running characteristics desired for guiding very elastic monofilaments or ribbons can be retained as a result of the sandwich-like arrangement of the single coatings.

In order to maintain the characteristic properties of the coating materials over the longest possible service life, a preferred embodiment of the invention is developed. In this development, the single coatings of the multiple coating each have a minimum layer thickness of >20 μm.

Hereby, it is particularly advantageous if an inner single coating has a layer thickness that is greater than that of an outer single coating by a factor of 5. Thus it is also possible to homogenize and protect rougher surface textures of the base body by means of a first single coating.

This division of the layer thicknesses has proved useful particularly in an envelopment of the invention in which the coating material of the outer single coating is formed by a sliding material for reducing friction, and the coating material of the inner single coating is formed by a protective material for minimizing wear.

The use of a ceramic as the protective material and the use of a plastic as the sliding material have proved particularly useful for this purpose. In particular, PTFE [polytetrafluoroethylene] is well-suited for use as the plastic in order to ensure very low-friction guidance of the monofilaments or ribbons.

For producing the maximum possible monofilaments or ribbons side by side, a preferred embodiment of the invention is developed in which the contact surface is formed on the guide element over a length of >1,000 mm thereof. Thus it is possible to realize large working widths in order to guide a plurality of monofilaments or ribbons.

In order to enable a uniform cooling or heating of each monofilament or ribbon, for example during the thermal treatment, it is necessary to spread the ribbons cut out from a film or the freshly extruded monofilaments. For this purpose, the guide element is preferably formed by a grooved rod that comprises a guide slot for each monofilament or ribbon and that forms the contact surface. Such types of grooved rods are preferably cylindrical in shape and they comprise circumferential guide slots that are provided with the multiple coating around the entire circumference and over the entire length of the grooved rod. It is thus possible to realize relatively large wrap angles of 60° and more.

Alternatively, it is also possible for the guide element to be formed by a guide strip comprising a plurality of protruding pins, which guide strip comprises the contact surface. It is thus possible to achieve a division and spread of the monofilaments or ribbons without large wrap angles.

For guiding the monofilaments or ribbons, the guide element is preferably assigned to any one of the treatment devices in an inlet zone and/or an outlet zone. If several treatment devices are used for producing a turf yarn, preferably several guide elements are assigned to several treatment devices in an inlet zone and/or an outlet zone each.

The apparatus according the invention will be explained below in more detail on the basis of an exemplary embodiment and with reference to the figures enclosed, in which:

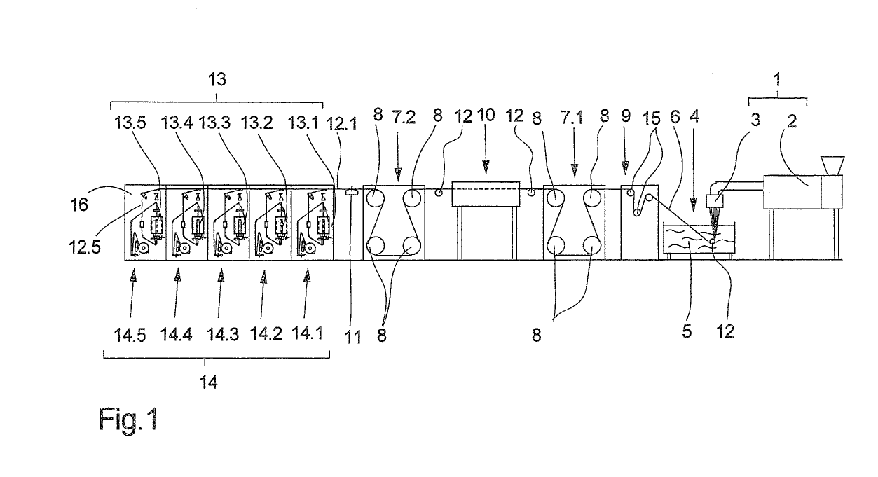

FIG. 1 schematically shows a side view of an exemplary embodiment of the apparatus of the invention

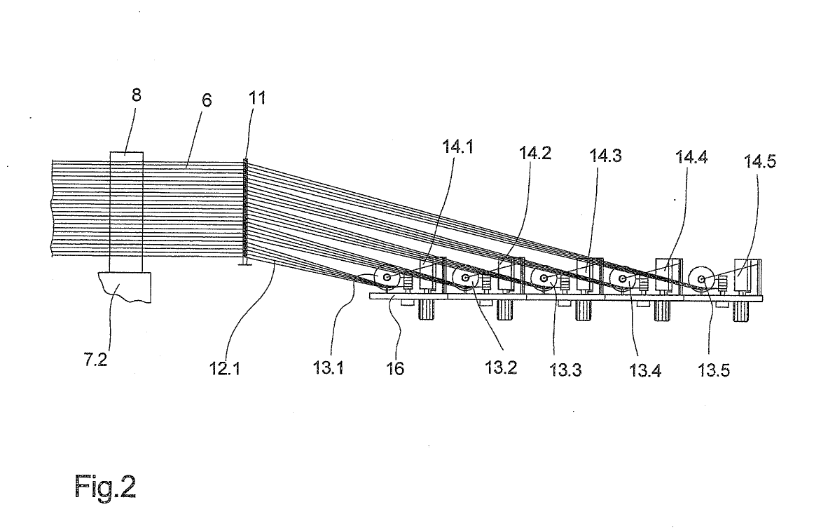

FIG. 2 schematically shows a section of a top view of the exemplary embodiment shown in FIG. 1

FIG. 3 schematically shows a partial view of a first exemplary embodiment of a guide element

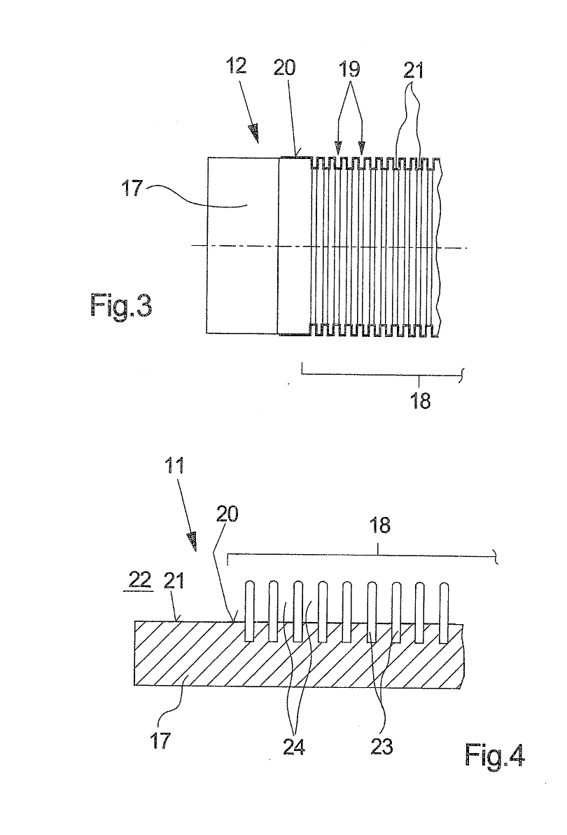

FIG. 4 schematically shows a partial view of an additional exemplary embodiment of a guide element

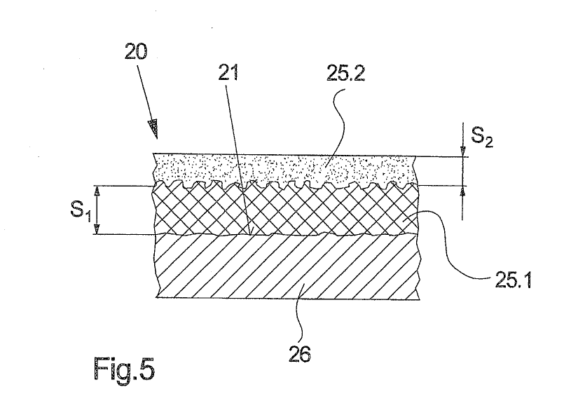

FIG. 5 schematically shows a cross-sectional view of the contact surface of a guide element

FIGS. 1 and 2 schematically show an exemplary embodiment of the apparatus of the invention for producing monofilaments. An overall view of the exemplary embodiment is shown in FIG. 1, and FIG. 2 schematically shows a partial view of the winding device and the spooling device. The following description applies to both figures unless express reference is made to any one of the figures.

FIG. 1 shows an overall view of the exemplary embodiment of the apparatus of the invention. The exemplary embodiment comprises an extrusion device 1 in order to extrude a thermoplastic material to form a plurality of monofilaments. For this purpose, the extrusion device 1 comprises an extruder 2 and a spinneret 3 connected to the extruder 2.

Several treatment devices are disposed downstream of the extrusion device in order to stretch the monofilaments or to join several monofilaments and spool the same in the form of fiber bundles. In this exemplary embodiment, the first treatment device is formed by a cooling device 4 assigned to the extrusion device 1. The cooling device 4 comprises a cooling bath 5 disposed directly below the spinneret 3. Inside the cooling bath 5, a grooved rod 12 is disposed in the form of a guide element in order to separate the extruded monofilaments 6 and guide the same through the cooling bath 5.

For drawing and stretching the monofilaments, there are several conveyor systems 7.1 and 7.2 disposed in series that comprise several driven godets 8, on the circumference of which the monofilaments 6 are guided so as to extend parallel to each other and wrap around the godets once.

Between the cooling device 4 and the first conveyor system 7.1, there is a deflection device 9 provided that comprises several deflection rollers 15, on the circumference of which the monofilaments 6 are guided so as to wrap around the deflection rollers once. The deflection rollers 15 are disposed directly downstream of the cooling device 4 in order to wipe off the cooling liquid of the cooling bath 5 clinging to the monofilaments 6.

A heating device 10 is disposed between the conveyor systems 7.1 and 7.2. In this exemplary embodiment, the heating device 10 is formed by a circulating air oven, in which the monofilaments 6 are heated to a stretching temperature. For guiding the monofilaments, there are grooved rods 12 disposed in an inlet zone and an outlet zone each of the heating device 10 in order to be able to guide the monofilaments 6 through the hot air oven of the heating device 10 so as to extend separately parallel to each other. For stretching the monofilaments 6, the godets 8 of the conveyor systems 7.1 and 7.2 are driven with a difference of speed.

After the stretching process, the monofilaments 6 are combined in groups to form fiber bundles and supplied to a winding device 13 and a spooling device 14. For this purpose, there is a thread-guide strip 11 disposed between the last conveyor system 7.2 and the winding device 13, on which thread-guide strip 11 the monofilaments are guided and divided into several fiber bundles.

As shown in FIG. 1 and FIG. 2, the winding device 13 comprises several winding stations, and the spooling device 14 comprises several spooling stations so that there is a winding station and a spooling station provided for each fiber bundle. In this exemplary embodiment, a total of five fiber bundles can be wound up into spools so that a total of five winding stations 13.1 to 13.5 and five spooling stations 14.1 to 14.5 are disposed along a side frame 16.

In the exemplary embodiment shown in FIGS. 1 and 2, the fiber bundles produced are preferably used further as turf yarn. The turf yarn is processed further to produce artificial turf. For this purpose, a thermoplastic material is fed to the extruder of the extrusion device in the form of granular material comprising, for example, PP [polypropylene] or LLDPE [linear low density polyethylene] or HDPE [high density polyethylene] or PA [polyamide] and extruded to form a dyed polymer melt. In doing so, the polymer melt preferably obtains a green color produced either by means of additives or dyed granular material. The polymer melt dyed in green color is extruded by means of the spinneret 3 to form a plurality of monofilaments 6. After their passage through the treatment devices, the monofilaments 6 are combined in groups and wound up in the form of fiber bundles to form spools.

Since such types of turf yarns exhibit high degree of elasticity, it is particularly necessary to guide the monofilaments with low friction. For this purpose, the guide elements such as the grooved rod 12 disposed inside the cooling bath 5 have a contact surface comprising a multiple coating. FIG. 3 shows an exemplary embodiment of such a grooved rod 12. FIG. 3 is only a partial view of the grooved rod. The grooved rod 12 comprises two opposing holding ends 17, only the left holding end 17 of the grooved rod 12 being shown in FIG. 3. A guide section 18 extends between the holding ends 17. There are several guide slots 19 formed side by side on the guide section 18. The guide slots 19 extend circumferentially parallel to each other around the circumference of the cylindrical guide section 18. The walls and bottom of the guide slots 19 each form the contact surface 21, on which the monofilaments are guided. In this exemplary embodiment, there is a multiple coating applied to the entire guide section 18 so that the non-contact surfaces formed on the guide section 18 are also coated apart from the contact surfaces 21. The structure of the multiple coating 20 on the contact surfaces 21 will be explained hereinafter in more detail.

FIG. 4 shows an additional embodiment of a guide element used in the form of a guide strip 11 in the exemplary embodiment shown in FIG. 1. In this case, the guide strip 11 comprises a holding end 17 and a guide section 18. The guide section 18 is formed on a top side of the guide strip 11. The top side of the guide strip 11 thus forms the contact surface 21, to which the multiple coating

20 is applied. A plurality of protruding pins 23 is attached to the top side 22 of the guide strip 11 so as to be disposed at a distance from each other. Thus a plurality of guide grooves 24 is formed, in which the monofilaments are guided side by side parallel to each other.

The exemplary embodiments of a guide element shown in FIGS. 3 and 4 are particularly well-suited to guide a plurality of monofilaments or ribbons side by side parallel to each other. Thus the contact surfaces 21 or the guide sections 18 extend over an overall length of 1,300 mm, for example. Thus it is possible to realize working widths of more than 1,000 mm in the exemplary embodiment shown in FIGS. 1 and 2.

In order to enable low-friction and wear-resistant guidance of the monofilaments on the contact surfaces as far as possible, there is a multiple coating 20 applied to the contact surface 21. FIG. 5 schematically shows a cross-sectional view of the multiple coating 20. In this exemplary embodiment, the multiple coating 20 is formed by an inner single coating 25.1 and an outer single coating 25.2 that are located on top of each other in a sandwich-like manner. The inner single coating 25.1 is applied directly to the contact surface 21 of the base body 26. The base body 26 can be the cylindrical guide section 18 of the grooved rod 12 or the flat guide section 18 of the thread-guide strip 11. The inner single coating 25.1 is applied with a layer thickness S₁. The outer single coating 25.2 is applied with a layer thickness of S₂ above the inner single coating 25.1. The outer single coating 25.2 comprises a sliding material as the coating material so that the guide surface oriented directly toward the monofilament is determined by the properties of the sliding material. By contrast, the coating material of the inner single coating 25.1 is formed by a protective material representing a wear-resistant coating for the base body 26. Preferably, a ceramic applied directly to the contact surface 21 of the base body 26 is used as the protective material. Such types of ceramic materials can be applied, for example, in the form of a plasma coating. The boundary surface between the inner single coating 25.1 and the outer single coating 25.2 is rough-textured in this exemplary embodiment so that the wear of the sliding material used in the outer coating 25.2 occurring in the operating state of the apparatus results in a mixed surface formed by portions of the sliding material and portions of the protective material. A special advantage of such a guide surface is that the monofilaments or ribbons can be guided with low friction and resistance to wear. Usually, plastics are used as the sliding material, and PTFE plastics (Teflon) have proven particularly advantageous for guiding monofilaments and ribbons.

In an exemplary embodiment of the grooved rod shown in FIG. 3, the guide section is initially coated with a plasma coating comprising a ceramic material with a layer thickness S₁ of approximately 0.3 mm. Then a PTFE coating is applied in a sandwich-like manner over the ceramic layer with a layer thickness S₂ of approximately 0.04 mm. In the combination of an outer sliding material and an inner protective material, a ratio of layer thicknesses has proven particularly advantageous in which the inner single coating 25.1 is larger than the outer single coating 25.2 by a factor of 5 (S₁>5x S₂).

The multiple coating shown in FIG. 5 merely serves as an example. In principle, it is also possible to apply more than two single coatings to a contact surface of the base body. Thus, for example, an outer nanocoating would also be possible in order to achieve special surface effects.

The exemplary embodiment of the apparatus of the invention shown in FIGS. 1 and 2 is particularly well-suited to guide monofilaments or ribbons between the treatment devices with low friction in spite of large wrap angles. In this connection, the multiple coating of the guide elements ensures long service life thereof.

The exemplary embodiment of the apparatus of the invention shown in FIGS. 1 and 2 is used for producing monofilaments. Such components of the apparatus are also suitable for producing a ribbon extruded from a film. In this case, the extrusion device would comprise an extruder head producing a flat film or a blown film that is cut into a plurality of ribbons after the setting process.

The configuration and arrangement of the treatment devices of the exemplary embodiment shown in FIGS. 1 and 2 and the guide elements are illustrated by way of example. In principle, additional treatment devices such as those used for an after-treatment or crimping of the monofilaments or ribbons can also be provided.

### LIST OF REFERENCE NUMERALS OR CHARACTERS

1 Extrusion device
2 Extruder
3 Spinneret
4 Cooling device
5 Cooling bath
6 Monofilaments
7.1, 7.2 Conveyor system
8 Godets
9 Deflection device
10 Heating device
11 Guide strip
12 Grooved rod
13 Winding device
13.1, 13.2, 13.3 Winding station
14 Spooling device
14.1, 14.2, 14.3 Spooling station
15 Deflection rollers
16 Side frame
17 Holding end
18 Guide section
19 Guide slot
20 Multiple coating
21 Contact surface
22 Top side
23 Pins
24 Guide grooves
25.1, 25.2 Single coating
26 Base body

1.-9. (canceled)

10. An apparatus for producing monofilaments or ribbons, said apparatus comprising:
an extrusion device;
several treatment devices; and
at least one rod-shaped guide element provided for guiding the monofilaments or ribbons, which guide element has a contact surface for guiding the ribbons or monofilaments,
wherein the contact surface has a multiple coating comprising several coating materials, the multiple coating being formed by several single coatings, each with a different layer thickness, and the single coatings being formed in a sandwich-like manner on the contact surface.

11. The apparatus of claim 10, wherein the single coatings of the multiple coating each have a minimum layer thickness of >20 μm.

12. The apparatus of claim 10, wherein an inner single coating has a layer thickness that is greater than that of an outer single coating by a factor of 5.

13. The apparatus of claim 12, wherein the coating material of the outer single coating is formed by a sliding material for reducing friction, and the coating material of the inner single coating is formed by a protective material for minimizing wear.

14. The apparatus as defined in claim 13, wherein the protective material is formed by a ceramic, and the sliding material is formed by a plastic, more particularly PTFE.

15. The apparatus of claim 10, wherein the contact surface is formed on the guide element over a length of >1,000 mm thereof.

16. The apparatus of claim 15, wherein the guide element is formed by a grooved rod that comprises a guide slot for each monofilament or ribbon and that comprises the contact surface.

17. The apparatus of claim 15, wherein the guide element is formed by a guide strip comprising a plurality of protruding pins, which guide strip comprises the contact surface.

18. The apparatus of claim 10, wherein the guide element is assigned to any one of the treatment devices or several guide elements are assigned to several treatment devices in an inlet zone and/or an outlet zone each.
